(19) United States
(12) Patent Application Publication
(10) Pub. No.: US 2016/0242989 A1
(43) Pub. Date: Aug. 25, 2016

(54) Plumping Device and Method

(71) Applicants: Sam Alexander, Draper, UT (US); Charles Simons, Atlanta, GA (US); Benoit Rabozzi, Vauxbuin (FR)

(72) Inventors: Sam Alexander, Draper, UT (US); Charles Simons, Atlanta, GA (US); Benoit Rabozzi, Vauxbuin (FR)

(21) Appl. No.: 14/626,771

(22) Filed: Feb. 19, 2015

(51) Int. Cl. A61H 7/00

(52) U.S. Cl. CPC A61H 7/00

(57) ABSTRACT

A lip and skin plumping device and method are presented utilizing a vacuum pump and controller to deliver a constant frequency pulsating suction to the skin. The constant frequency allows blood to pulse through the affected area to reduce stress and trauma to the treated skin. The device is hand-held and may have tips to fit lips or be used around the eyes.

### BACKGROUND OF THE INVENTION

For aesthetic reasons, many individuals desire to have plumper lips and to plump the areas around the eyes. Various devices have been invented that increase blood flow to these areas resulting in better color and the desired plumping effect. These devices may employ a vacuum pump to pull the skin into a cavity. The drawback to these devices is that prolonged pulling can damage the skin and stretch it. Even devices with easy-to-operate manual switches require the user to self-time the pulsations which does not result in achieving optimal results.

### BRIEF SUMMARY OF THE INVENTION

A plumping device is provided which utilizes a vacuum pump and a pressure relief valve which is switched open and closed at a constant and optimal frequency for the pulsation at the skin. The constant frequency provides benefits such as better circulation, less likelihood of bruising and consistent effects.

### BRIEF DESCRIPTION OF THE DRAWINGS

FIG. 1 is a perspective transparent view of one embodiment of the present invention;

FIG. 2 is a perspective transparent view of the bottom of one embodiment of the present invention; and

FIG. 3 is an elevational transparent view of one embodiment of the present invention.

### DETAILED DESCRIPTION OF THE PREFERRED EMBODIMENTS

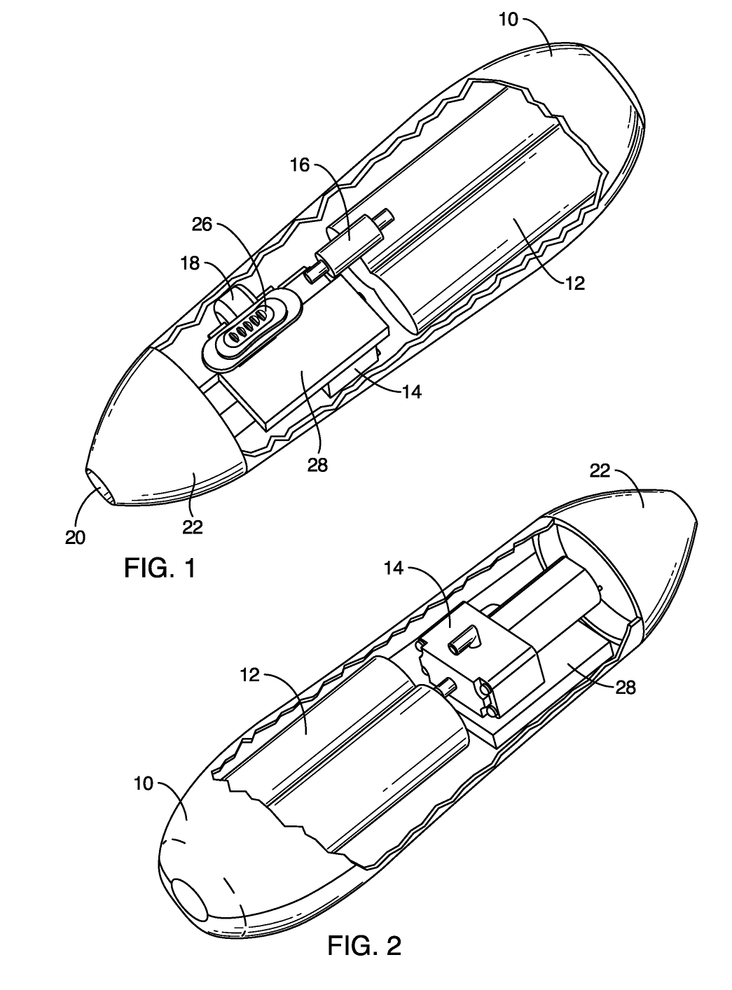

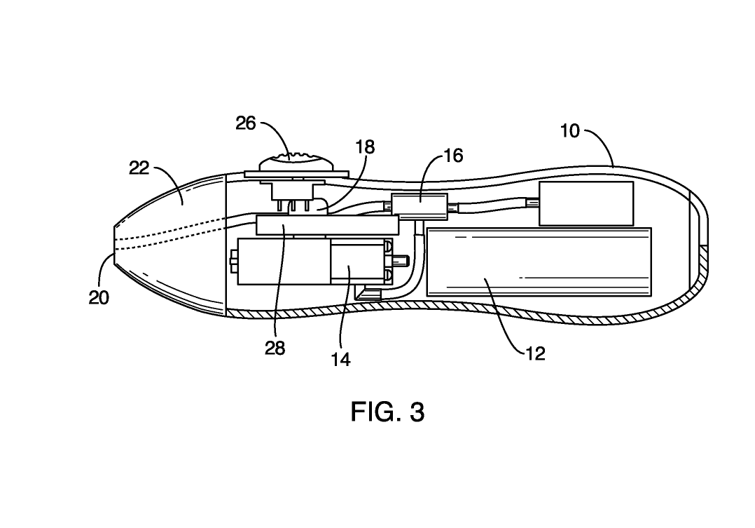

Referring first to the embodiment illustrated in FIG. 1, a case 10 surrounds and encapsulates the parts of the hand-held device and is shaped to be easily held. Case 10 holds a battery box 12 which contains batteries with enough capacity to power the device for several periods of use before recharging or replacement. Battery box 12 contains at least one battery that energizes vacuum pump 14 which creates negative pressure and is connected to hoses and hose connector 16 which convey the negative pressure up through a filter 18 and into a cavity created inside cap 22. An opening 20 formed in the end of cap 22 allows the negative pressure to reach the atmosphere. When placed against the skin of a user, the negative pressure pulls the skin of the user against or slightly into opening 20. A pressure relief valve 24 cycles between an open and closed position at a fixed frequency. When switch 26 is activated, a circuit board 28 controls vacuum pump 14 and pressure relief valve 24 to present a negative pressure pulsation at opening 20 thereby pulling in and then releasing the skin of a user. Switch 26 can be used to select from one of three positions, on/off, the first of two fixed frequencies for the occillation created by the pulsation of pressure relief valve 24 and a second fixed frequency, each no less than 0.1 Hz and no greater than 3 Hz. The two frequencies are selected from within the range of 0.1 Hz to 3.0 Hz, wherein each frequency is a unique and constant frequency within that range.

One embodiment of the present invention utilizes an electro-mechanical valve and a constant frequency pulsation circuit to cycle the vacuum pressure of the device. The constant frequency provides many benefits over other devices. The first relates to the effect of a constant frequency. The manual release of a valve while consistent will never be able to maintain a constant frequency over a period of time. In maintaining an accurate consistency in the frequency of the vacuum pulsation, a better effect is achieved. Specifically in the application of use on a human's skin, the consistency of pulsation will have a stronger effect on the circulation to the target area of the skin than pulsation at an inconsistent frequency. Additionally, the automatic pulsation provides a premium benefit to the customer due to removing the need to constantly press a button to achieve the stronger effect. The use of a consistent frequency also provides a stronger effect on the subject than a continuous vacuum/suction as well.

One embodiment utilizes an electro mechanical valve in-line with the vacuum pump to release the suction felt at the tip. The electro mechanical valve is controlled at a fixed frequency by a controller.

Another embodiment utilizes a mechanical valve in-line with the vacuum pump and releases suction when air flow is reduced. The vacuum pump is controlled at a fixed frequency by a controller such that power is reduced to the pump so that the mechanical valve opens and closes at a desired fixed frequency.

The alternation of suction and non-suction achieved by an automatic pulsation control within the device allows for optimal limp plumping through the pulling and releasing of blood flow and an increase in circulation via pulsation. This also reduces the risk of bruising and other potential suction damage by allowing recovery via oxygen during the intermittent suction. Not only is this safer, it also provides consistent results by providing optimal blood flow to increase the fullness and size of the lips and areas around the eyes.

What is claimed and desired to be secured by Letters Patent is:

1. A plumping device for use on lips and around eyes comprising:
a) a vacuum pump;
b) a circuit board;
c) a constant frequency pressure controller; and
d) a case enclosing the components of the device.

2. A plumping device as recited in claim 1, wherein the constant frequency pressure controller is configured to sense a current or power consumption of the vacuum pump and to disconnect or reduce the power of the pump when a vacuum level generated by the pump exceeds a safety threshold.

3. A plumping device as recited in claim 1, wherein the constant frequency pressure controller is a pressure relief valve.

4. A plumping device as recited in claim 1, wherein the circuit board times the vacuum pump on and off.

5. A plumping device as recited in claim 3, wherein the vacuum pump produces the same level of negative pressure and the circuit board switches the pressure relief valve between an on and off position.

6. A plumping device as recited in claim 1, wherein an electro-mechanical valve is switched on and off by the circuit board.

7. A plumping device as recited in claim 1, wherein the suction created by the vacuum pump is interrupted at a constant frequency set so that the skin of the user may return to its original position before being sucked back into the device.

8. The device of claim 1, further comprising a surface covered with exfoliating material for applying on the lip or lips of the user.

9. The device of claim 1 further configured to apply a cosmetic material on the lip or lips of the user.

10. A method for lip and skin plumping, the method comprising:
a) covering a portion of a lip of a user by a vacuum applicator and applying vacuum; and
b) controlling operation of the vacuum applicator at a constant fixed frequency using a control unit.

11. A method for lip plumping as recited in claim 10, wherein the vacuum applicator is pulsed at a constant frequency.

12. A method for lip plumping as recited in claim 11, wherein the frequency allows the lip to return to its original position before having vacuum reapplied.
